(19) United States
(12) Patent Application Publication
(10) Pub. No.: US 2002/0110386 A1
(43) Pub. Date: Aug. 15, 2002

(54) Process cartridge, image forming apparatus and separating mechanism for separating developing member from photosensitive drum

(76) Inventors: Kazuhiko Kanno, Odawara-shi (JP); Kojiro Yasui, Shizuoka-ken (JP); Tadashi Horikawa, Susono-shi (JP); Susumu Nittani, Shizuoka-ken (JP); Tatsuya Suzuki, Shizuoka-ken (JP); Koji Yamaguchi, Numazu-shi (JP)

Correspondence Address: FITZPATRICK CELLA HARPER & SCINTO, 30 ROCKEFELLER PLAZA, NEW YORK, NY, 10112, US

(21) Appl. No.: 10/066,665

(22) Filed: Feb. 6, 2002

(30) Foreign Application Priority Data
Feb. 9, 2001 (JP) 033350/2001(PAT.)
Sep. 19, 2001 (JP) 285144/2001(PAT.)
Jan. 11, 2002 (JP) 004313/2002(PAT.)

(51) Int. Cl. G03G 21/16

(52) U.S. Cl. 399/111; 399/228

(57) ABSTRACT

A process cartridge detachably mountable to a main assembly of an electrophotographic image forming apparatus, includes a first frame; a second frame coupled with the first frame for rotation about a shaft; an electrophotographic photosensitive drum provided in the first frame; a developing member, provided in the second frame, for developing an electrostatic latent image formed on the photosensitive drum with a developer; a developing member, provided in the second frame, for developing an electrostatic latent image formed on the photosensitive drum with a developer; an elastic member for applying an elastic force between the first frame and the second frame to urge the developing member to the photosensitive drum; a force receiving portion, provided downstream of the shaft with respect to a mounting direction in which the process cartridge is mounted to the main assembly of the image forming apparatus, for receiving a force from the main assembly of the image forming apparatus to keep the developing member away from the photosensitive drum when the process cartridge is mounted to the main assembly of the image forming apparatus; and a limiting portion for limiting upward movement of the first frame.

### FIELD OF THE INVENTION AND RELATED ART

The present invention relates to a process cartridge, an electrophotographic image forming apparatus using the same, and a separating mechanism for separating a developing member from an electrophotographic photosensitive drum. The present invention is particularly suitably usable with a color electrophotographic image forming apparatus.

The electrophotographic image forming apparatus forms an image on a recording material through an electrophotographic image formation type process. The electrophotographic image forming apparatus may be an electrophotographic copying machine, an electrophotographic printer (a LED printer, a laser beam printer or the like), an electrophotographic printer type facsimile machine, an electrophotographic printer type word processor or the like.

The process cartridge is a cartridge or unit which contains as a unit at least an electrophotographic photosensitive drum and developing means (developing member) and which is detachably mountable to a main assembly of an electrophotographic image forming apparatus.

In an image forming apparatus using an electrophotographic image forming process, a process cartridge type in which an electrophotographic photosensitive member and process means actable on said electrophotographic photosensitive member are contained as a unit in a process cartridge which is detachably mountable to the main assembly of the image forming apparatus, has been used. The process cartridge type is advantageous in that maintenance operations can be performed not by a service person but by the user in effect, and therefore, operation property has been significantly improved. Therefore, the process cartridge type is widely used in the electrophotographic image forming apparatus.

As shown in FIG. 13, there is a color electrophotographic image forming apparatus 200 for a line type in which a plurality of process cartridges are arranged in a line. As for developing means for such cartridges, two types of structures are known. (1) A contact developing system in which the developing roller is kept in contact with the electrophotographic photosensitive drum in the developing operation, and (2) a non-contact developing system in which a predetermined gap is maintained between the photosensitive drum and the developing roller in the developing operation. In either of the types, a predetermined contact pressure or gap is maintained between the developing roller and said photosensitive drum during the intermediate, by urging the developing roller toward the photosensitive drum.

However, in the case of the cartridge of the contact developing system, the developing roller is press-contacted or urged to the photosensitive drum. In other words, an elastic layer of the developing roller is contacted to the photosensitive drum with a predetermined contact pressure. Therefore, if the cartridge is not operated for a long term with the cartridge being set in the main assembly of the image forming apparatus, there is a possibility of permanent deformation of the elastic layer of the developing roller. Because of this, the developed image can be non-uniform.

When the developing roller is not supplied with a bias voltage during the non-operation period (non-image formation), the toner on the developing roller may be deposited on the photosensitive drum. Such toner is liable to contaminate the recording material or the like.

In order to solve this problem, an image forming apparatus has been proposed in which when the image forming operation is not carried out, the developing roller is kept away from the photosensitive drum.

### SUMMARY OF THE INVENTION

Accordingly, it is a principal object of the present invention to provide a process cartridge, an electrophotographic image forming apparatus and a separating mechanism for separating the developing member from the electrophotographic photosensitive drum, in which the developing member (developing roller, for example) is assuredly separated from the electrophotographic photosensitive member.

It is another object of the present invention to provide a process cartridge, an electrophotographic image forming apparatus and a separating mechanism for separating the developing member from the electrophotographic photosensitive drum, in which the developing member can be assuredly separated from the electrophotographic photosensitive member, and they can be brought into contact to each other with certainty.

It is a further object of the present invention to provide a process cartridge, an electrophotographic image forming apparatus and a separating mechanism for separating the developing member from the electrophotographic photosensitive drum, in which the developing member is assuredly separated from the electrophotographic photosensitive member except for the developing operation, but during the developing operation, the time is assuredly contacted to the electrophotographic photosensitive member with a predetermined contact pressure.

It is a further object of the present invention to provide a process cartridge, an electrophotographic image forming apparatus and a separating mechanism for separating the developing member from the electrophotographic photosensitive drum, in which when the image forming operation is not carried out, the developing member is assuredly contacted to the photosensitive drum during the image forming operation.

According to an aspect of the present invention, there is provided a process cartridge detachably mountable to a main assembly of an electrophotographic image forming apparatus, comprising a first frame; a second frame coupled with said first frame for rotation about a shaft; an electrophotographic photosensitive drum provided in said first frame; a developing member, provided in said second frame, for developing an electrostatic latent image formed on said photosensitive drum with a developer; a developing member, provided in said second frame, for developing an electrostatic latent image formed on said photosensitive drum with a developer; an elastic member for applying an elastic force between said first frame and said second frame to urge said developing member to said photosensitive drum; a force receiving portion, provided downstream of said shaft with respect to a mounting direction in which said process cartridge is mounted to the main assembly of said image forming apparatus, for receiving a force from the main assembly of the image forming apparatus to keep said developing member away from said photosensitive drum when said process cartridge is mounted to the main assembly of the image forming apparatus; and a limiting portion for limiting upward movement of said first frame.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 shows a general arrangement of a color electrophotographic image forming apparatus according to an embodiment of the present invention.

FIG. 2 is a schematic sectional view of a process cartridge.

FIG. 3 is an exploded perspective view of a process cartridge.

FIG. 4 illustrates a separating mechanism of a cartridge in a main assembly of the apparatus.

FIG. 5 illustrates a separating mechanism of a cartridge in a main assembly of the apparatus.

FIG. 6 illustrates a separating mechanism of a cartridge in a main assembly of the apparatus.

FIG. 7 illustrates a separating and contacting the developing roller to the photosensitive drum.

FIG. 8 illustrates a separating and contacting the developing roller to the photosensitive drum.

FIG. 9 is an illustration of a force receiving portion of the developing unit.

FIG. 10 is an illustration of another example of urging member for between the photosensitive member unit and the developing unit.

FIG. 11 is a perspective view of a process cartridge when it is mounted to the main assembly of apparatus.

FIG. 12 is a perspective view of a process cartridge which is mounted to the main assembly of apparatus.

FIG. 13 is an illustration of a conventional electrophotographic image forming apparatus.

### DESCRIPTION OF PREFERRED EMBODIMENTS

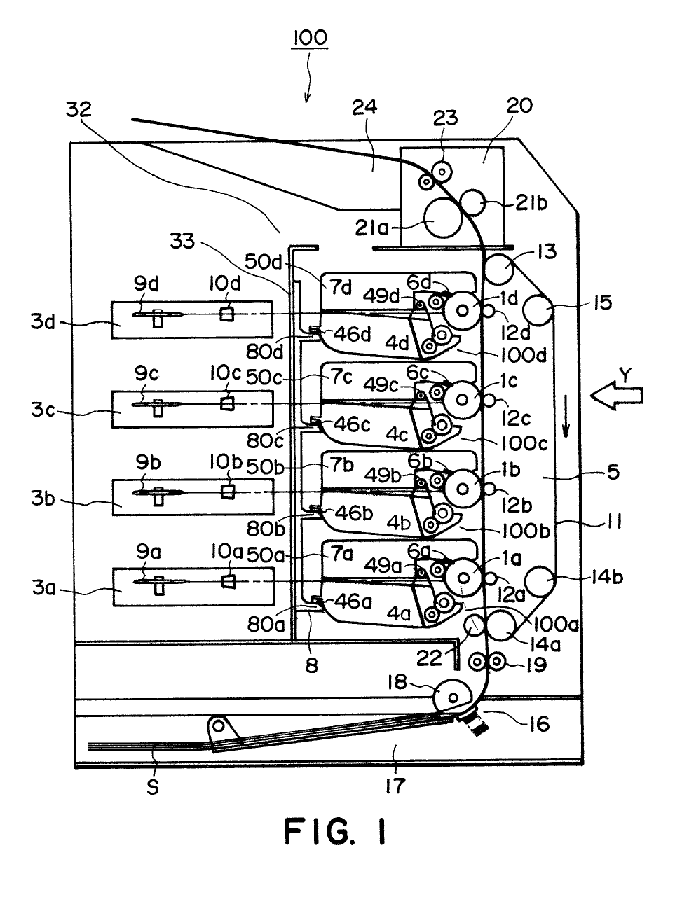

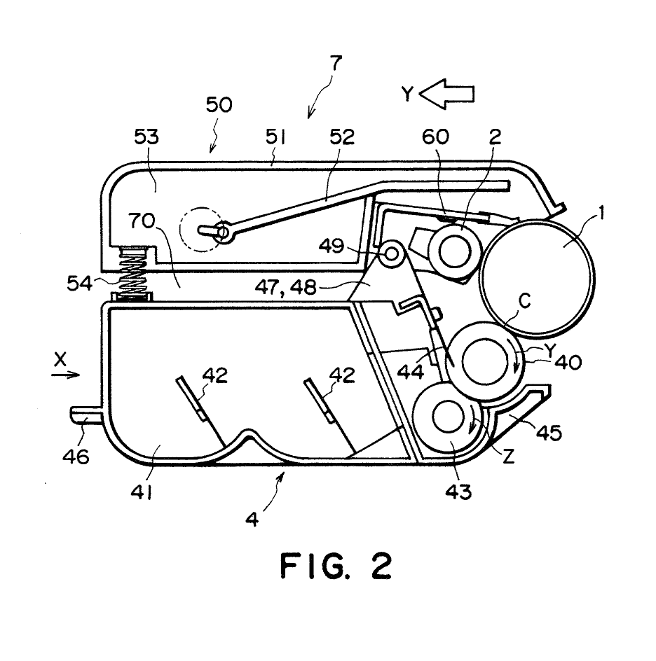

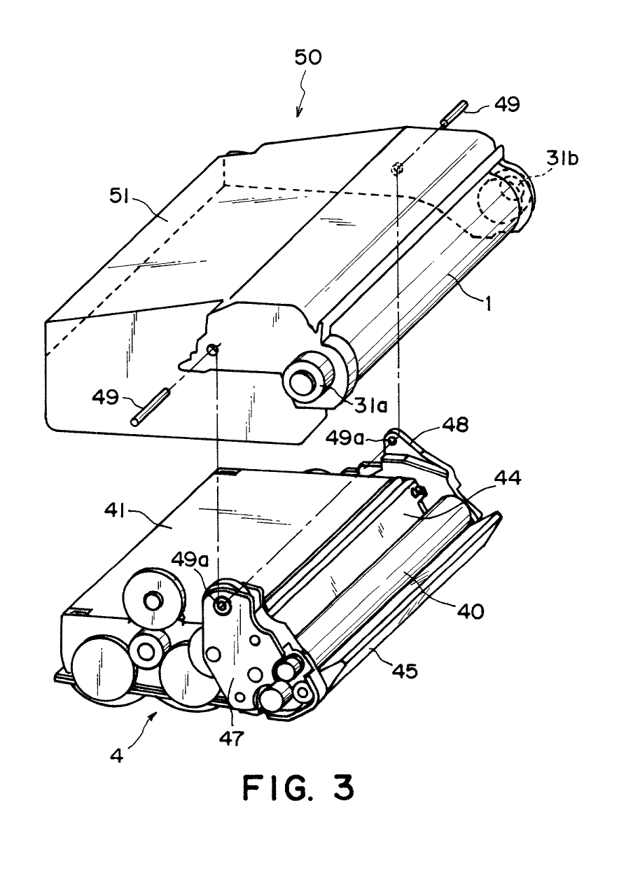

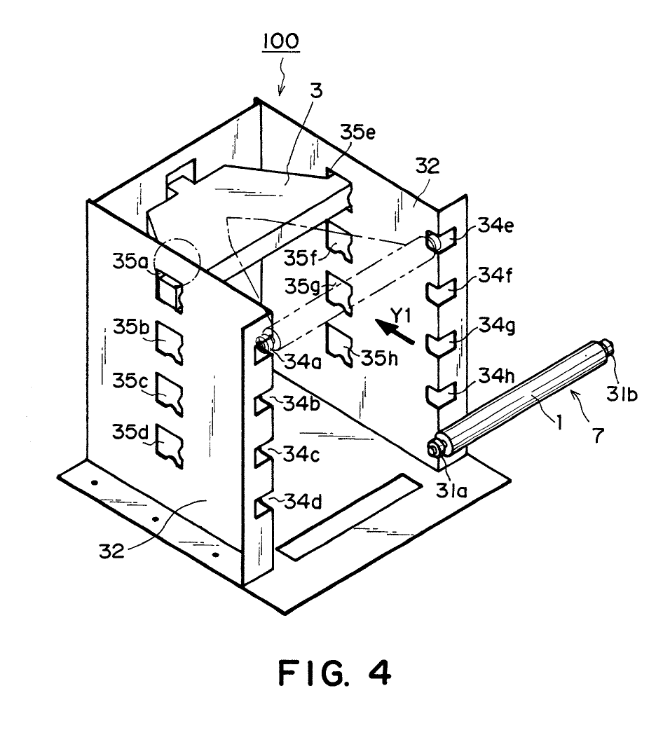

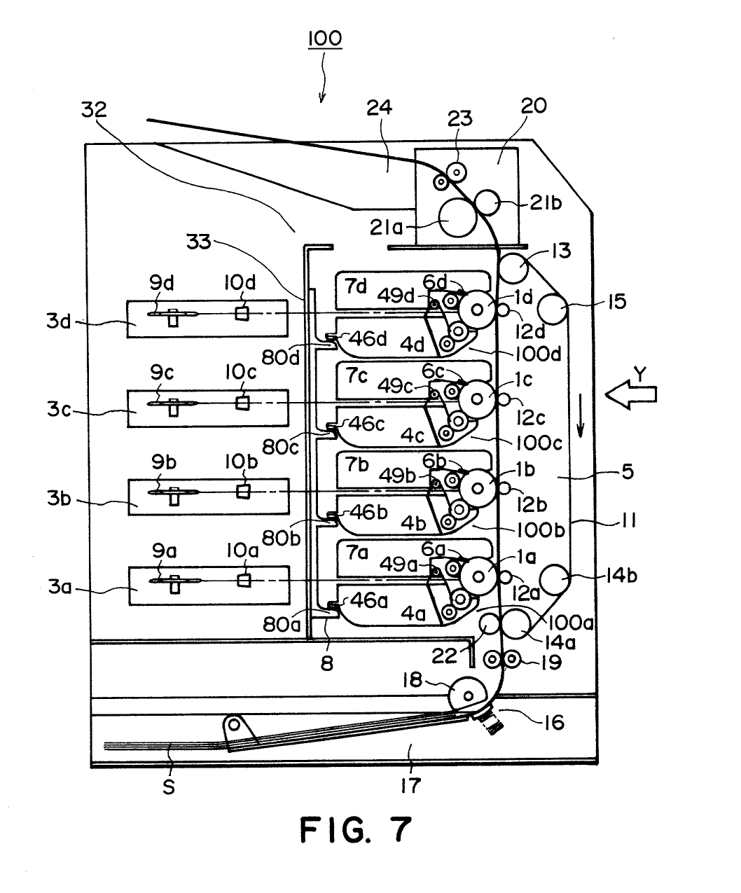

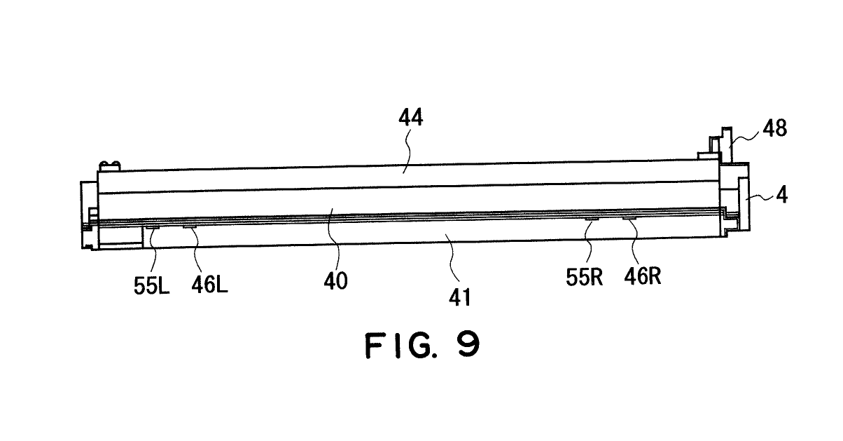

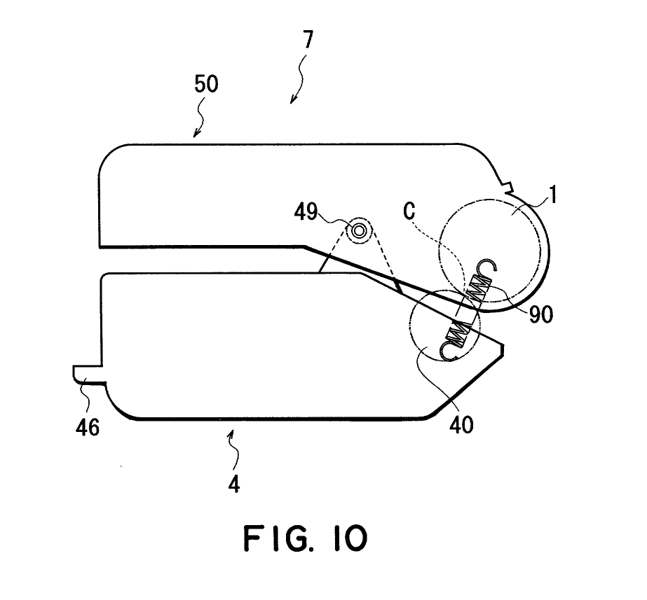

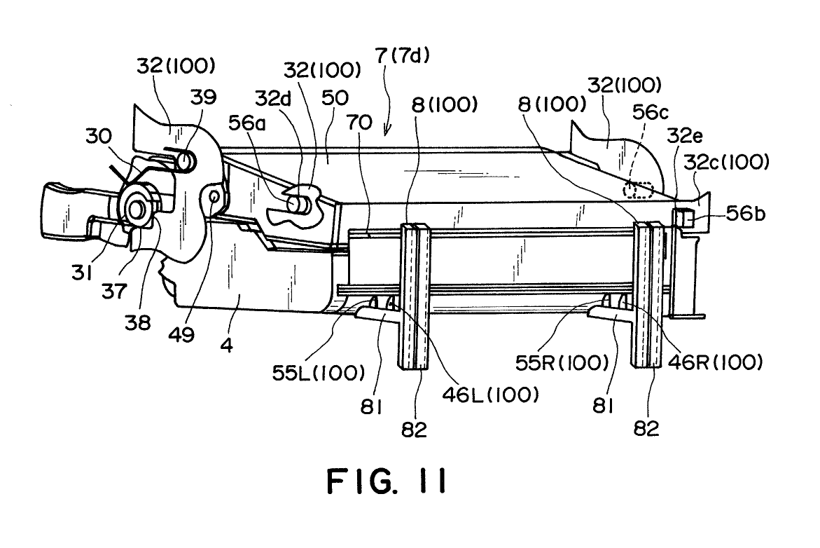

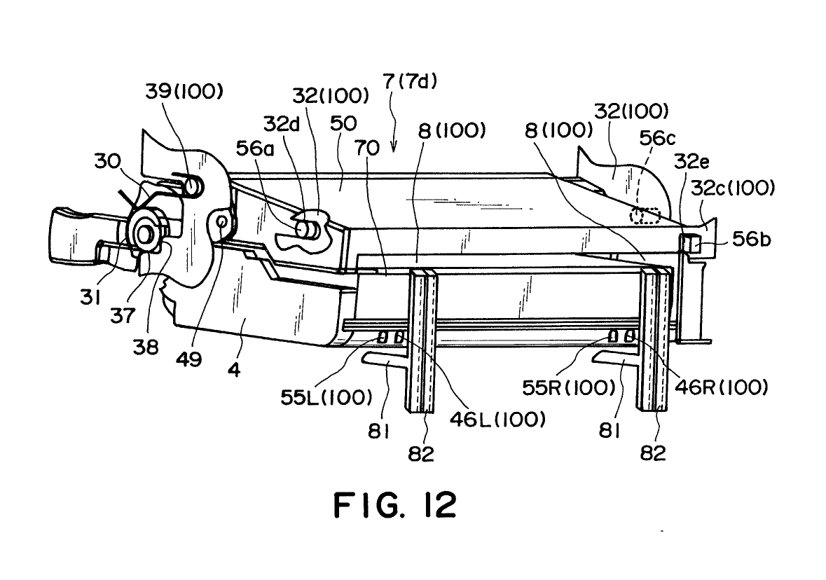

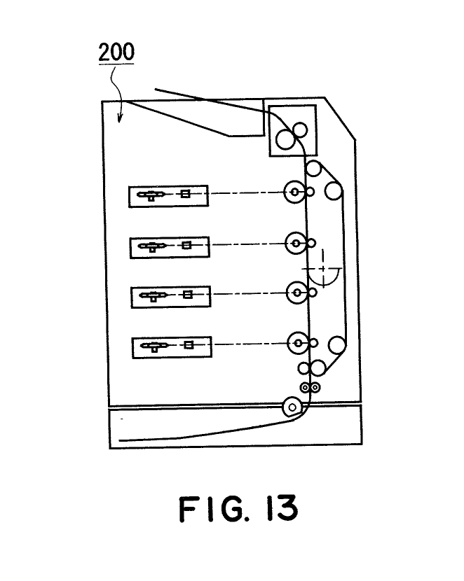

The description will be made as to a process cartridge and a color electrophotographic image forming apparatus according to an embodiment of the present invention in conjunction with the accompanying drawings. FIG. 1 shows a general arrangement of a color electrophotographic image forming apparatus according to an embodiment of the present invention; FIG. 2 is a schematic sectional view of a process cartridge; FIG. 3 is an exploded perspective view of the cartridge; FIG. 4 through FIG. 6 are illustrations of a separating mechanism of the 8 in the main assembly of the apparatus; FIGS. 7 8 are illustrations of the separation and contact actions of the developing roller relative to the photosensitive drum; FIG. 9 is an illustration of a force receiving portion of the developing unit; FIG. 10 is an illustration of another example of the urging member for between the photosensitive member unit and the developing unit; FIGS. 11 and 12 are perspective views of the cartridge set in the main assembly of apparatus.

(General Arrangement of Image Forming Apparatus)

Referring to FIG. 1, the description will be made as to the general arrangement of image forming apparatus. The image forming apparatus 100 shown in FIG. 1 has four process cartridge mounting portions (100a-100d) which are arranged in the vertical direction. The cartridges 7 mounted to the mounting portions are image provided with one electrophotographic photosensitive drum (1a-1d). The photosensitive drum 1 is rotated in the counterclockwise direction in the Figure by a driving means (unshown). Around the photosensitive drum 1, there are provided the following elements in the order name in the direction of peripheral movement of the photosensitive drum 1. Charging means (2a-2d) for uniformly charging the surface of the photosensitive drum 1; a scanner unit (3a-3d) for forming an electrostatic latent image on the photosensitive drum 1 by projection of the laser beam in accordance with image information; developing unit (4a-4d) (second frame) for developing the electrostatic latent image with a developer (toner); electrostatic transferring means 5 for transferring the toner image from photosensitive drum 1 onto a recording material S; cleaning means for removing the toner remaining on surface of photosensitive drum 1 after the image transfer. Here, the photosensitive drum 1, the charging means 2, the developing unit 4 and the cleaning means 6 are unified into a process cartridge.

The photosensitive drum 1 comprises an aluminum cylinder having a diameter of 30 mm, for example and an organic light direction transmission member layer (OPC photosensitive member) applied on outer surface thereof. The photosensitive drum 1 is rotatably support at the opposite and portions by supporting members. At one of the end portions, a driving force is transmitted from a driving motor (unshown). By this, the photosensitive drum 1 is rotated in the counterclockwise direction. The charging means 2 in this embodiment is a contact charging type charging means, and shown in FIG. 2. The charging member is an electroconductive roller which is contacted to the surface of the photosensitive drum 1. The roller (2a-2d) is supplied with a charging bias voltage. By doing so, the surface of the photosensitive drum 1 is uniformly charged electrically.

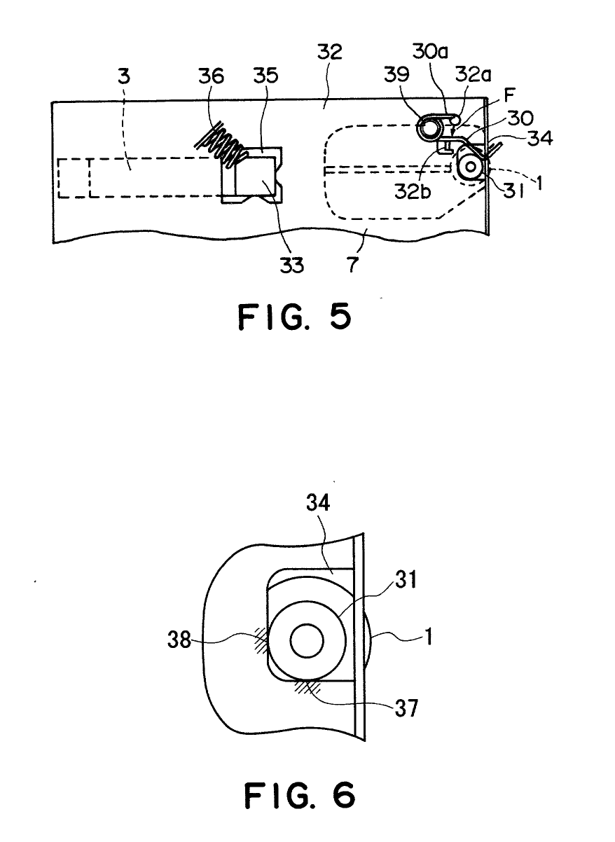

The scanner unit 3 is disposed substantially add the same level as the photosensitive drum 1. The image light corresponding to the image signal emitted by a laser diode (unshown) is directed to a polygonal mirror 9a-9d rotated by a scanner motor (unshown). The surface of the photosensitive drum 1 having been electrically charged is selectively exposed to image light reflected by the mirror 9 through an imaging lens 10a-10d. By this, an electrostatic latent image is formed in accordance with the image signal. The unit 3 is longer than a length between the left and right plates in the longitudinal direction as shown in FIG. 5. A projection 33 is projected outward through an opening 35a-35h formed in the left and right plate 32. The unit 3 is urged in the direction indicated by the arrow (downward and 45° inclination) by a compression spring 36 with approx. 9.8N. By doing so, the unit 3 is assuredly urged and currently positioned.

As shown in FIG. 2, the developing unit 4 includes a toner container 41a accommodating yellow color toner, a toner container 41b containing magenta color toner, a toner container 41c containing cyan color toner, and toner container 41d containing black color toner, and a developing device frame 45. A toner feeding mechanism 42 is provided to feed the toner from the inside of the toner container 41 to the toner supplying roller 43. The toner is applied on the outer periphery of the developing roller 40 by a developing blade 44 press-contacted to the outer periphery of the developing roller 40. And, the toner is electrically charged. The developing roller 40 is supplied with a developing bias so that latent image formed on the photosensitive drum 1 is developed. The developing roller 40 is disposed opposed to the photosensitive drum 1.

On the other hand, as shown in the Figure, the image forming apparatus comprises an electrostatic transfer belt 11 which moves along an endless path so that it is opposed to all of the photosensitive drums 1a-1d. The transfer belt 11 is made of a material having a thickness of approx. 150 μm and having a volume resistivity of 10¹¹-10¹⁴ Ωcm. The transfer belt 11 is supported by four rollers (4 axes) and travels in the vertical direction. The recording material S is fed to the image transfer station by the transfer belt 11, where the toner image is transferred from the photosensitive drum 1 onto the recording material S. The transfer rollers 12a-12d are opposed to the photosensitive drums 1a-1d and are contacted to the inside of the transfer belt 11. The positive charge is applied to the recording material S from the transfer roller 12 to the transfer belt 11. By this, the toner image is transferred from the photosensitive drum 1 onto the recording material S. The transfer belt 11 is extended on four rollers, namely, a driving roller 13, follower rollers 14a, 14b and a tension roller 15, and is rotatable in the direction indicated by an arrow in FIG. 1. With this arrangement, the toner image is transfer onto the recording material S while the recording material S is fed from the follower roller 14a side to the driving roller 13 side by the circulation movement of the transfer belt 11.

The feeding portion 16 functions to supply the recording material S to the image formation station. A plurality of recording materials S are accommodated in the feeding cassette 17. During the image formation, a feeding roller 18 and registration rollers 19 are rotated in accordance with the image forming operation. The recording material S is fed out of the cassette 17 in seriatim. And, the leading end of the recording material S is abutted to the nip formed between the rollers 19. The recording material S is fed to the transfer belt 11 by the registration rollers 19 in a timed relation with the rotation of the transfer belt 11 and the toner image on photosensitive drum.

The fixing portion 20 functions to fix the toner images of different colors having been transferred onto the recording material S. The fixing means comprises a rotatable heating roller 21a and a pressing roller 21b press-contacted to the heating roller 21a to apply heat and pressure to the recording material S. The recording material S now having the toner image transferred from the photosensitive drum 1 is fed by the fixing rollers 21 while it is passed through the fixing portion 20. During it being fed, the heat and pressure is applied to the recording material by the pair of fixing rollers 21. By this, the toner image of the plurality of colors are fixed on the surface of the recording material S.

The image forming operation will be described. The cartridges 7a-7d are sequentially driven in synchronism with image forming operation. By this, the photosensitive drum 1a-1d are rotated. Then, the scanner units 3 for the cartridges 7 are sequentially actuated. Then, the charging means 2 electrically charges the surface of the photosensitive drum 1 uniformly. The peripheral surface of the photosensitive drum 1 is exposed to the light modulated in accordance with an image signal, so that an electrostatic latent image is formed on the photosensitive drum 1. The developing roller 40 develops the electrostatic latent image.

As described in the foregoing, the toner image is sequentially transferred from the photosensitive drums 1 onto the recording material S by the electric fields formed between the photosensitive drums 1 and the transfer rollers 12. The recording material S now having the transferred four color toner image is separated from the transfer belt 11 by the curvature of the driving roller 13. Then, it is fed into the fixing station 20. The toner image is fixed on the recording material S by the heat and pressure in the fixing portion 20, and thereafter, it is discharged to outside of the main assembly from the discharging portion 24 by the discharging rollers 23.

(Process Cartridge)

Referring to FIG. 2, the description will be made as to the process cartridge according to an embodiment of the present invention. FIG. 2 is a section of view and a perspective view of the cartridge 7 accommodating the toner. The cartridge 7a accommodating normal yellow color toner, a cartridge 7b accommodating magenta color toner, cartridge 7c accommodating cyan color toner, and cartridge 7d accommodating black color toner, have the same structures.

The cartridge 7 (7a-7d) comprises a photosensitive member unit 50 (50a-50d) (first frame) including a photosensitive drum 1 (1a-1d), charging means 2 (2a-2d) and cleaning means 6 (6a-6d), a developing unit 4 (4a-4d) (second frame) including developing means.

In the unit 50, the photosensitive drum 1 is rotatably mounted to the cleaning frame 51 by bearings 31a, 31b. Around the photosensitive drum 1, there is provided charging means 2 and the cleaning blade 60. The residual toner removed from the surface of the photosensitive drum 1 by the cleaning blade 60, is fed into a removed toner chamber 53 provided behind the cleaning frame, by a toner feeding mechanism 52. The unit 50 receives a driving force from a driving motor (unshown), by which the photosensitive drum 1 is rotated for image forming operation.

The developing unit 4 comprises a developing roller 40 which is rotatable in the direction indicated by an arrow Y in contact with the photosensitive drum 1, a toner container 41 accommodating the toner, and a developing device frame 45. The developing roller 40 is rotatably supported on the developing device frame 45 by bearing members. As described in the foregoing, the peripheral surface of the developing roller 40 is contacted by the developing roller 40, the toner supplying roller 43 and the developing blade 44. In the toner container 41, there is provided a toner feeding mechanism 42 for stirring the toner accommodated therein and for feeding the toner to the roller 43.

The developing unit 4 as a whole is pivotably mounted to the photosensitive member unit 50. More particularly, the developing unit 4 is rotatable relative to the unit 50 about the shaft shaft 49 (pivot) engaged in the holes 49a of bearing members 47, 48 mounted to the opposite ends of the unit 4. When the cartridge 7 is not mounted to the main assembly of the printer, the developing unit 4 is normally urged by a pressing spring 54 (compression coil spring) and a pressing spring 90 (elastic members) so that developing roller 40 is contacted to the photosensitive drum 1 by the rotation moment about the shaft 49. The toner container 41 of the developing unit 4 is integrally provided with a force receiving portion 46 (46a-46d) in the form of a rib for abutment by a separation means (which will be described hereinafter) of the main assembly 100 of the apparatus when the developing roller 40 is to be separated from the photosensitive drum 1. The shaft 49 is provided between the developing roller 40 and the rear end of the toner container 41. The developing roller 40 is spaced from the photosensitive drum 1 with a predetermined gap therebetween by raising the force receiving portion 46. At this time, by the regulating portion which will be described hereinafter in conjunction with FIG. 11 and FIG. 12, the unit 50 is prevented from upward movement.

In the case of a contact developing system in which the developing operation is carried out while the developing roller 40 is in contact with the photosensitive drum 1, it is preferable that photosensitive drum 1 is rigid, and the developing roller 40 is elastic. The elastic member may be a solid rubber monolayer, or a solid rubber layer coated with a risen material in consideration of the charging application property to the toner.

(Separation Mechanism for Separation Between Photosensitive Drum and Developing Member in Process Cartridge)

Referring to FIG. 4 through FIG. 12, the description will be made as to a separation mechanism which is operative when the cartridge 7 dismounted to the main assembly 100 of the apparatus. In FIG. 4, the cartridge 7 is omitted, and only the photosensitive drums 1 and the bearings are shown, for better understanding of the cartridge 7 mounting structure. FIG. 11 and FIG. 12 are perspective views of the cartridge 7 in which the cartridge 7 is mounted to the main assembly. In FIG. 11, the force receiving portions 55L, 55R are raised by a force applying member 8. FIG. 12 shows a state in which the force receiving portions 55L, 55R and the force applying member 8 are spaced from each other.

As described in the foregoing, in the cartridge 7 per se (not mounted to the main assembly of apparatus), the developing roller 40 (developing member) is normally contacted to the photosensitive drum 1. In the mounting to the main assembly 100 of the apparatus, the bearing supporting the photosensitive drum 1 is inserted along the guide grooves 34a-34h (FIG. 4 in which the cartridge mounting direction is indicated by an arrow). As shown in FIG. 6, the 31 is pressed against the abutment surfaces 37, 38 of the guide groove 34, by which the position of the cartridge 7 is determined relative to the main assembly of the apparatus. The urging method of the cartridge 7 in the main assembly of apparatus will be described. As shown in FIG. 5, the shaft 39 is crimped to the side plate 32. A twisted coil spring 30 is supported on the shaft 39. The end 30a is fitted into the hole 32a and is fixed there. When the cartridge 7 is not mounted to the main assembly of apparatus, the spring 30 is limited by the erected portion 32b in the rotational direction. When the cartridge 7 is inserted, the spring 30 is rotated in the counterclockwise direction against the spring force of the spring 30. When it rides over the bearing, it elastically urges the bearing 31.

Referring to FIGS. 1, 7 and FIG. 8 the description will be made as to, the separation means will be described. In a rear side of the main assembly 100 of the apparatus with respect to the inserting direction of the cartridge 7, there is provided a separation means (force applying member 8) for separating in the developing roller 40 from the photosensitive drum 1 against the urging force of the developing unit 4. The force applying member 8 has separation plates 80a-80d for raising the force receiving portions 46a-46d provided in the developing units 4a-Dd for the yellow, magenta, cyan and black developers. The force applying member 8 is moved vertically by a stepping motor (unshown). The separation plate 80 of the force applying means 8 is movable between a separation position in which it raises the receiving portions 46a-46d by which the developing roller 40 is separated from the photosensitive drum 1 (separation position) and a developing position image the separation plate 80 is not raised and takes a lower position so that separation plate 80 is separated from the force receiving portions 46a-46d, and therefore, developing roller 40 is contacted to the photosensitive drum 1. Only during the image forming operation, the raising of the separation plate 80 is disabled so as to move the developing unit 4 to the developing position. By releasing the raising action of the separation plate 80, the developing roller 40 is brought into contact to the photosensitive drum 1 by the elastic force of the spring 54.

FIG. 9 is a view of the cartridge 7 as seen in the direction indicated by an arrow X in the FIG. 2.

With this structure, there are provided two pairs of receiving portions 46L, 46R, 55L, 55R arranged in the longitudinal direction of the cartridge 7. When the separation plate 80 is raised so that developing roller 40 is separated from the photosensitive drum 1, the separation plate 80 is contacted simultaneously to the force receiving portions 46R, 46L or to the force receiving portion 55L, 55R. By doing so, the developing roller 40 is prevented from being separated with inclination in the longitudinal direction. In FIGS. 1, 2, 7 and FIG. 8, the example in which the force receiving portion 46 is projected frontward with respect to the mounting direction Y (FIG. 2), is shown. In FIGS. 9, 11 and FIG. 12, the example in which the force receiving portions 46, 55 are provided on the lower surface of the unit 4 and are oriented downward.

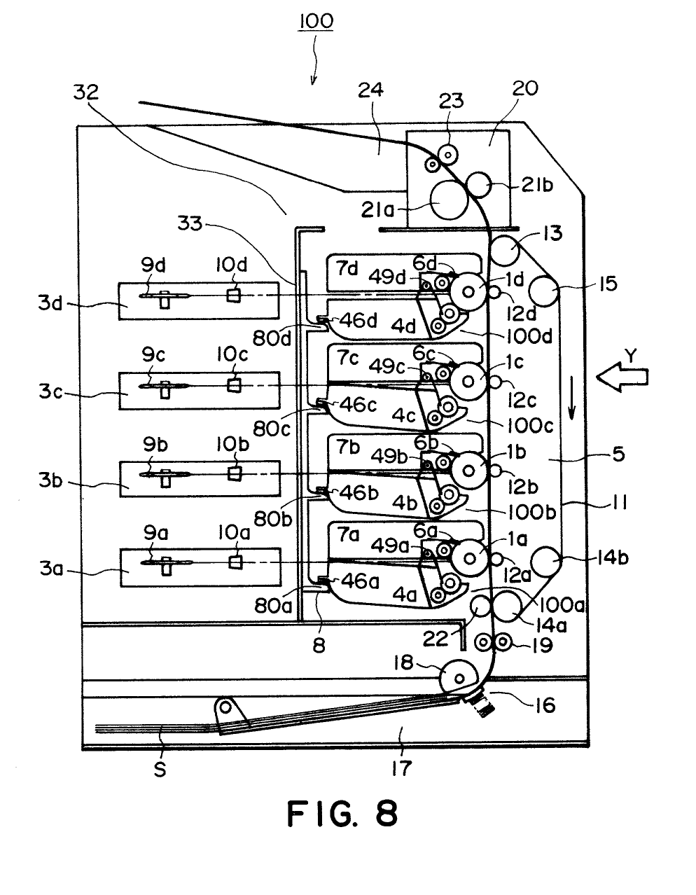

The releasing of the raising of the separation plate 80 includes three modes, namely, (1) the separation plate 80 is raised for all of the cartridges 7a-7d for the yellow, magenta, cyan and black colors (FIG. 1), (2) the separation plate 80 is not raised for any of the cartridges 7a-7d for the yellow, magenta, cyan or black color (FIG. 7), (3) the separation plate 80 is raised only for the cartridges 7a-7d for the yellow, magenta and cyan colors (FIG. 8). In order to make these three modes selectable, the toner container 41 is provided with two pairs of force receiving portions as shown in FIG. 9, in this embodiment. The cartridge 7 (7a-7c) accommodating the yellow color, magenta color and cyan color developers are brought into and out of contact, using the force receiving portions 46L, 46R. On the other hand, the cartridge 7 (7d) accommodating the black color developer is brought into and out of contact, using the force receiving portions 55L, 55R. The main assembly of apparatus has two pairs of separation plates 80 for the cartridge 7 (7a-7c) accommodating the yellow color, magenta color and cyan color developers and for the cartridge 7 (7d) accommodating the black color developer.

In this embodiment, when the cartridge 7 is mounted to the main assembly 100 of apparatus, the separation plate 80 is raised for the yellow, magenta, cyan and black color cartridges 7 (all cartridges), as shown in Figure. Therefore, with the mounting operation of the cartridge 7, the force receiving portion 46 provided in the developing unit 4 rides on the separation plate 80. By doing so, the developing roller 40 is separated from the photosensitive drum 1 by a predetermined gap. The separated state is maintained in the period in which the main switch is not actuated, or the developing operation is not carried out. Therefore, even if the cartridge 7 is left unused for a long term with the cartridge 7 set in the main assembly, the permanent deformation of the developing roller layer which may occur as a result of long-term contact of the developing roller 40 to the photosensitive drum 1.

When the image forming operation is started in response to the printing signal, the raising of the separation plate 80 is released at a timed relation with the developing operation. By this, the separation plate 80 lowers. The force receiving portions 46, 55 is separated from the separation plate 80. Then, the developing roller 40 is brought into contact to the photosensitive drum 1 by the elastic force of the spring 54, and the operable state of developing action is established. In the case of a full color mode, the developing roller 40 is contacted to the photosensitive drum 1 in all of the cartridges 7 for the yellow, magenta, cyan and black, as shown in FIG. 7. Thus, the separation plate 80 is separated from the force receiving portions 46, 55. In the case of a monocolor mode, the developing roller 40 is contacted to the photosensitive drum 1 only in the cartridge 7d for the black color, as shown in FIG. 8. Thus, the separation plate 80 is separated from the force receiving portions 46, 55. In this manner, the image forming operations are carried out corresponding to the respective color modes.

The foregoing embodiment is summarized as the following process cartridge. That is:

A process cartridge detachably mountable to a main assembly (100) of an electrophotographic image forming apparatus, comprising:

a first frame (photosensitive drum unit 50);

a second (4) frame coupled with said first frame for rotation about a shaft (49);

an electrophotographic photosensitive drum (1) provided in said first frame;

a developing member (developing roller 40), provided in said second frame, for developing an electrostatic latent image formed on said photosensitive drum with a developer; a developing member, provided in said second frame, for developing an electrostatic latent image formed on said photosensitive drum with a developer (t);

an elastic member (spring 54, 90) for applying an elastic force between said first frame and said second frame to urge said developing member to said photosensitive drum;

a force receiving portion (46, 55), provided downstream of said shaft with respect to a mounting direction (Y in FIG. 2) in which said process cartridge is mounted to the main assembly of said image forming apparatus, for receiving a force from the main assembly of the image forming apparatus to keep said developing member away from said photosensitive drum when said process cartridge is mounted to the main assembly of the image forming apparatus; and

a limiting portion (56a, 56b) for limiting upward movement of said first frame.

The limiting portion 56a is engaged with a locking portion 32d provided in the side plate 32. The limiting portion 56 is engaged with a locking portion 32C of a rear side plate 32c provided in the main assembly 100 of the apparatus. By doing so, the force from the main assembly 100 of the apparatus is applied to the force receiving portions 46, 55, so that upward movement of the unit 50 is prevented. Therefore, the downstream side of the unit D with respect to the mounting direction Y is raised rotationally about the shaft 49. By this, the developing roller 40 is separated from the photosensitive drum 1. The limiting portion 56a functions as a guide when the cartridge 7 is mounted to the main assembly 100. The limiting portion 56b functions as a guide for positioning the cartridge relative to the main assembly 100.

The force receiving portions 46, 55 are provided at one and the other longitudinal and portions of the developing unit 4.

The force receiving portions 46, 55 are provided at two positions (46L, 55L) at one longitudinal end of portion of the developing unit 4 and at two positions (46R, 55R). The four force receiving portions 46L, 46R, 55L, 55R face the award when the cartridge 7 is mounted to the main assembly 100 of the apparatus. When the cartridge 7d contains the developer for black color development, one force receiving portion 55L at said one end portion and one force receiving portion 55R at the other end portion receive the upward force from the main assembly 100 of the apparatus. In the case of the cartridge 7a-7c containing the developer for long-black color development, the other force receiving portion 46L disposed at one end portion and the other force receiving portion 46R at the other end portion received the force from the main assembly 100 of the apparatus.

A process cartridge 7 further comprises laser beam path 70 for permitting passage of a laser beam to be projected onto the photosensitive drum 1 from the main assembly 100 of the image forming apparatus when the process cartridge 7 is mounted to the main assembly 100 of an image forming apparatus. The laser beam path 70 is disposed between the frame 50 the frame 4 at a downstream portion with respect to the mounting direction (Y), The force receiving portion is disposed at such a position that force receiving portion does not interfere the laser beam path 70 with respect to a vertical direction when the process cartridge 7 is mounted to the main assembly 100 of image forming apparatus. By this, the force applying means 8 provided in the main assembly 100 of apparatus does not block the optical path for the laser beam.

The contact position C where the photosensitive drum 1 and the developing roller 40 are contacted to each other (FIG. 2), is disposed upstream of the shaft 49 in the mounting direction Y (FIG. 2).

The limiting portion 56a (FIGS. 11, 12) is disposed at one end portion of the unit 50 with respect to a direction crossing with the mounting direction Y and at a downstream side with respect to the mounting direction Y, and is projected from the unit 50 in the crossing direction.

The limiting portion 56C indicated by chain lines with three dots in FIGS. 11, 12, is disposed at the other end portion of the unit 50 with respect to a direction crossing with the mounting direction Y and at a downstream portion with respect to the mounting direction Y, and is projected from the unit 50 in the crossing direction. In this embodiment, a limiting portion 56C is provided in place of the limiting portion 56b shown in FIG. 11 and FIG. 12. Therefore, this embodiment uses the limiting portion 56a and the limiting portion 56C in combination.

The limiting portion 56b (FIGS. 11, 12) is disposed at the other end portion of the unit 50 with respect to the direction crossing with the mounting direction Y and that leading end portion in the mounting direction Y, and is projected from the unit 50 toward the downstream with respect to the mounting direction Y.

The process cartridge further includes, at one and the other longitudinal end of portions of the photosensitive drum 1, a member (bearing 31) disposed coaxially with a photosensitive drum 1. When the cartridge 7 is mounted to the main assembly 100 of apparatus, the spring 30 provided in the main assembly 100 of apparatus is pressed elastically against the bearing 31.

The spring (said elastic member) is disposed at each of one on the other longitudinal and portions of the unit 4 and unit 50. At one end portion, there is provided a pressing spring 54 in the form of a compression coil spring, and at the other end portion, there is provided a pressing spring 90 in the form of a stretching spring. With this structure, the developing roller 40 can be stably urged to the photosensitive drum 1.

The mounting portion 100d of the main assembly 100 includes one mounting means 100d for mounting a process cartridge 7d for black color development and three mounting means 100a-100c for mounting the process cartridges 7a-7c for non-black color development, and wherein the force applying portion 8 includes a first force applying means 81 for applying the force to the force receiving portion 55L, 55R of the process cartridge 7d for black color development mounted to the mounting means 100d therefor, and second force outlined means 82 for applying the force to the force receiving portion 46L, 46R of the process cartridges 7a-7d for non-black color development. The first force applying means 81 and the second force applying means 82 are movable in the vertical direction independently from each other.

The separating mechanism is summarized as follows:

A separating mechanism for separating a developing member (40) from an electrophotographic photosensitive drum provided in a process cartridge detachably mountable, said separating mechanism comprising:

(A) a main assembly (100) of an electrophotographic image forming apparatus, to which the process cartridge is detachably mountable, said main assembly including a force applying means (8); and

(B) a mounting portion for mounting said process cartridge, said process cartridge including,

a first frame (photosensitive drum unit 50);

a second frame (developing unit 4) coupled with said first frame for rotation about a shaft (49);

an electrophotographic photosensitive drum (1) provided in said first frame;

a developing member (developing roller 40), provided in said second frame, for developing an electrostatic latent image formed on said photosensitive drum with a developer (t);

an elastic member (spring 54) for applying an elastic force between said first frame and said second frame to urge said developing member to said photosensitive drum;

a force receiving portion (46, 55), provided downstream of said shaft with respect to a mounting direction (Y in FIG. 2) in which said process cartridge is mounted to the main assembly of said image forming apparatus, for receiving a force from the main assembly of the image forming apparatus to keep said developing member away from said photosensitive drum when said process cartridge is mounted to the main assembly of the image forming apparatus; and

a limiting portion (56a, 56b) for limiting upward movement of said first frame.

wherein a force for raising said second frame upwardly is applied to said force receiving portion by said force applying means of said main assembly of said image forming apparatus while said regulating portion limits the upward movement of said first frame, to keep said developing member away from said photosensitive drum.

As described in the foregoing, the cartridge 7 comprises the developing unit 4 and the photosensitive member unit 50 which are pivotable about the shaft 49 (pivoted). When the cartridge 7 is not mounted to the main assembly of the apparatus, the developing unit 4 is normally urged by the spring 54 in the direction of contacting the developing roller 40 to the photosensitive drum 1. Therefore, when the separating action is released, that is, during the image forming operation, a stabilized contact pressure is applied to the photosensitive drum 1 by the spring pressure of the spring 54 alone, without the inclines of the other structures of the main assembly.

As shown in FIG. 10, the pressing spring may be a stretching spring fall applying a tension force between the neighborhood of the center of the photosensitive drum 1 and the neighborhood of the center of the developing roller. It is a possible alternative to use the compression coil spring (pressing spring 54) shown in FIG. 2 and the stretching spring (pressing spring 90) shown in FIG. 10 in combination. In the foregoing embodiment, the spring 54 and the spring 90 are used in combination as shown in FIGS. 2 and 10.

In this embodiment, the two pairs of force receiving portions 46L, 46R, 55L, 55R are used and are arranged in the axial direction of the photosensitive drum 1. However, more force receiving portions may be used depending on the mode control. On the other hand, only one force receiving portion may be used. In this embodiment, the cartridge 7d for the black color development and the cartridges 7a-7c for the non-black color development are used. For this reason, at least two force receiving portions are necessary. However, if this is not the case, only one force receiving portion is enough. However, from the standpoint of assured separating action, it is preferable to use a plurality of force receiving portions.

In this embodiment, the description has been made with respect to the developing apparatus of a contact developing system, but the present invention is applicable to a non-contact developing system. In this case, the present invention is effected to avoid production of a trace of pressing by a spacer roller for example.

As described in the foregoing, according to these embodiments, the two states, namely, contact and separation between the photosensitive drum and the developing roller, are easily selectively established. Therefore, the permanent deformation of the roller due to the contact of the developing roller to the photosensitive drum can be assuredly avoided. By releasing the separating action only during the image forming operation, the deposition of the developer from the developing roller to the photosensitive drum can be avoided when the bias voltage is not applied to the process cartridge. Therefore, the possible contamination of the recording media due to the developer can be avoided.

According to the present invention, the electrophotographic photosensitive drum and the developing member can be separated with certainty. They can be separated with a simple structure.

While the invention has been described with reference to the structures disclosed herein, it is not confined to the details set forth and this application is intended to cover such modifications or changes as may come within the purpose of the improvements or the scope of the following claims.

What is claimed is:

1. A process cartridge detachably mountable to a main assembly of an electrophotographic image forming apparatus, comprising:
a first frame;
a second frame coupled with said first frame for rotation about a shaft;
an electrophotographic photosensitive drum provided in said first frame;
a developing member, provided in said second frame, for developing an electrostatic latent image formed on said photosensitive drum with a developer; a developing member, provided in said second frame, for developing an electrostatic latent image formed on said photosensitive drum with a developer;
an elastic member for applying an elastic force between said first frame and said second frame to urge said developing member to said photosensitive drum;
a force receiving portion, provided downstream of said shaft with respect to a mounting direction in which said process cartridge is mounted to the main assembly of said image forming apparatus, for receiving a force from the main assembly of the image forming apparatus to keep said developing member away from said photosensitive drum when said process cartridge is mounted to the main assembly of the image forming apparatus; and
a limiting portion for limiting upward movement of said first frame.

2. A process cartridge according to claim 1, wherein said force receiving portion is disposed at each of longitudinal end portions of said second frame.

3. A process cartridge according to claim 2, wherein said force receiving portion is provided at two positions at said one longitudinal end portion and at two positions at the other longitudinal end portion, wherein said four force receiving portions face downward when said process cartridge is amounted to the main assembly of the image forming apparatus, wherein for said process cartridge accommodating a developer for development with black color, one of said force receiving portions disposed at said one longitudinal end portion and one of said force receiving portions disposed at the other longitudinal end portion receive the force from the main assembly of apparatus; for said process cartridge accommodating a developer for development with color other than black color, the other of said force receiving portions disposed at said one longitudinal end portion and the other of said force receiving portions disposed at the other longitudinal end portion receive the force from the main assembly of apparatus.

4. A process cartridge according to claim 2, further comprising a laser beam path for permitting passage of a laser beam to be projected onto said photosensitive drum from the main assembly of the image forming apparatus when said process cartridge is mounted to the main assembly of an image forming apparatus, said laser beam path being disposed between said first frame and said second frame at a downstream portion with respect to the mounting direction, wherein said force receiving portion is disposed at such a position that said force receiving portion does not interfere the laser beam path with respect to a vertical direction when said process cartridge is mounted to the main assembly of image forming apparatus.

5. A process cartridge according to claim 4, wherein a position where said developing member which is in the form of a developing roller is contacted to said photosensitive drum, is upstream of said shaft with respect to the mounting direction.

6. A process cartridge according to claim 1 or 2, wherein said linking portion is disposed at one end portion of said first frame with respect to a direction crossing with the mounting direction and at a downstream position with respect to the mounting direction, and said limiting portion is projected from said first frame with respect to the direction crossing with the mounting direction.

7. A process cartridge according to claim 2, wherein said limiting portion is disposed at the other end portion of said first frame with respect to a direction crossing with the mounting direction and at a downstream position with respect to the mounting direction, and said limiting portion is projected from said first frame with respect to the direction crossing with the mounting direction.

8. A process cartridge according to claim 6, wherein said limiting portion is disposed at the other end portion of said first frame with respect to a direction crossing with the mounting direction and at a leading end portion with respect to the mounting direction, and said limiting portion is projected from said first frame toward downstream with respect to the mounting direction.

9. A process cartridge according to claim 2, further comprising a member disposed at a position on an axis of said photosensitive drum at one on the other longitudinal end of said photosensitive drum, wherein a spring provided in the main assembly of image forming apparatus elastically presses against the member when said process cartridge is mounted to the main assembly of the image forming apparatus.

10. A process cartridge according to claim 2, wherein said plastic member is disposed at one and the other longitudinal and portions of the laser beam path at such a position as not to interfere the laser beam path.

11. A process cartridge detachably mountable to a main assembly of an electrophotographic image forming apparatus, comprising:
a first frame;
a second frame coupled with said first frame for rotation about a shaft;
an electrophotographic photosensitive drum provided in said first frame;
a developing roller, provided in said second prime, for developing an electrostatic latent image formed on said photosensitive drum with a developer;
a stretching spring for applying an elastic force between said first frame and said second frame to urge said developing member to said photosensitive drum;
a laser beam path for permitting passage of a laser beam to be projected onto said photosensitive drum from the main assembly of the image forming apparatus when said process cartridge is mounted to the main assembly of an image forming apparatus, said laser beam path being disposed between said first frame and said second frame at a downstream portion with respect to the mounting direction;
a force receiving portion, provided downstream of said shaft with respect to a mounting direction in which said process cartridge is mounted to the main assembly of said image forming apparatus, for receiving a force from the main assembly of the image forming apparatus to keep said developing member away from said photosensitive drum when said process cartridge is mounted to the main assembly of the image forming apparatus; and
wherein said force receiving portion is disposed at one and the other longitudinal and portions at such a position that said force receiving portion does not interfere the laser beam path with respect to a vertical direction when said process cartridge is mounted to the main assembly of image forming apparatus;
a first limiting portion for limiting upward movement of said first frame, wherein said first limiting portion is disposed at one end portion of said first frame with respect to a direction crossing with the mounting direction and at a downstream position with respect to the mounting direction, and said first limiting portion is projected from said first frame with respect to the direction crossing with the mounting direction;
a second limiting portion for limiting upward movement of said first frame, wherein said second limiting portion is disposed at the other end portion of said first frame with respect to a direction crossing with the mounting direction and at a downstream position with respect to the mounting direction, and said second limiting portion is projected from said first frame with respect to the direction crossing with the mounting direction;
wherein a contact position where said developing roller is contacted to said photosensitive drum is upstream of said shaft.

12. A process cartridge detachably mountable to a main assembly of an electrophotographic image forming apparatus, comprising:
a first frame;
a second frame coupled with said first frame for rotation about a shaft;
an electrophotographic photosensitive drum provided in said first frame;
a developing roller, provided in said second prime, for developing an electrostatic latent image formed on said photosensitive drum with a developer;
a stretching spring for applying an elastic force between said first frame and said second frame to urge said developing member to said photosensitive drum;
a laser beam path for permitting passage of a laser beam to be projected onto said photosensitive drum from the main assembly of the image forming apparatus when said process cartridge is mounted to the main assembly of an image forming apparatus, said laser beam path being disposed between said first frame and said second frame at a downstream portion with respect to the mounting direction;
a force receiving portion, provided downstream of said shaft with respect to a mounting direction in which said process cartridge is mounted to the main assembly of said image forming apparatus, for receiving a force from the main assembly of the image forming apparatus to keep said developing member away from said photosensitive drum when said process cartridge is mounted to the main assembly of the image forming apparatus; and
wherein said force receiving portion is disposed at one and the other longitudinal and portions at such a position that said force receiving portion does not interfere the laser beam path with respect to a vertical direction when said process cartridge is mounted to the main assembly of image forming apparatus;
a first limiting portion for limiting upward movement of said first frame, wherein said first limiting portion is disposed at one end portion of said first frame with respect to a direction crossing with the mounting direction and at a downstream position with respect to the mounting direction, and said first limiting portion is projected from said first frame with respect to the direction crossing with the mounting direction;
a second limiting portion for limiting upward movement of said first frame, wherein said second limiting portion is disposed at the other end portion of said first frame with respect to a direction crossing with the mounting direction and at a downstream position with respect to the mounting direction, and said second limiting portion is projected from said first frame with respect to the direction crossing with the mounting direction;
wherein a contact position where said developing roller is contacted to said photosensitive drum is upstream of said shaft. Wherein a contact position where said developing roller is contacted to said photosensitive drum is upstream of said shaft.

13. An electrophotographic image forming apparatus for forming an image on a recording material, to which a process cartridge is detachably mountable, said apparatus comprising:
(A) a force applying means;
(B) a mounting portion for mounting said process cartridge, said process cartridge including,
a second frame coupled with said first frame for rotation about a shaft;
an electrophotographic photosensitive drum provided in said first frame;
a developing member, provided in said second frame, for developing an electrostatic latent image formed on said photosensitive drum with a developer;
an elastic member for applying an elastic force between said first frame and said second frame to urge said developing member to said photosensitive drum;
a force receiving portion, provided downstream of said shaft with respect to a mounting direction in which said process cartridge is mounted to the main assembly of said image forming apparatus, for receiving a force from the main assembly of the image forming apparatus to keep said developing member away from said photosensitive drum when said process cartridge is mounted to the main assembly of the image forming apparatus; and
a limiting portion for limiting upward movement of said first frame.

14. An electrophotographic image forming apparatus for forming an image on a recording material, to which a process cartridge is detachably mountable, said apparatus comprising:
(A) a force applying means;
(B) a mounting portion for mounting said process cartridge, said process cartridge including,
a second frame coupled with said first frame for rotation about a shaft;
an electrophotographic photosensitive drum provided in said first frame;
a developing roller, provided in said second prime, for developing an electrostatic latent image formed on said photosensitive drum with a developer;
a stretching spring for applying an elastic force between said first frame and said second frame to urge said developing member to said photosensitive drum;
a laser beam path for permitting passage of a laser beam to be projected onto said photosensitive drum from the main assembly of the image forming apparatus when said process cartridge is mounted to the main assembly of an image forming apparatus, said laser beam path being disposed between said first frame and said second frame at a downstream portion with respect to the mounting direction;
a force receiving portion, provided downstream of said shaft with respect to a mounting direction in which said process cartridge is mounted to the main assembly of said image forming apparatus, for receiving a force from the main assembly of the image forming apparatus to keep said developing member away from said photosensitive drum when said process cartridge is mounted to the main assembly of the image forming apparatus; and
wherein said force receiving portion is disposed at one and the other longitudinal and portions at such a position that said force receiving portion does not interfere the laser beam path with respect to a vertical direction when said process cartridge is mounted to the main assembly of image forming apparatus;
a first limiting portion for limiting upward movement of said first frame, wherein said first limiting portion is disposed at one end portion of said first frame with respect to a direction crossing with the mounting direction and at a downstream position with respect to the mounting direction, and said first limiting portion is projected from said first frame with respect to the direction crossing with the mounting direction;
a second limiting portion for limiting upward movement of said first frame, wherein said second limiting portion is disposed at the other end portion of said first frame with respect to a direction crossing with the mounting direction and at a downstream position with respect to the mounting direction, and said second limiting portion is projected from said first frame with respect to the direction crossing with the mounting direction;
wherein a contact position where said developing roller is contacted to said photosensitive drum is upstream of said shaft.

15. An electrophotographic image forming apparatus for forming an image on a recording material, to which a process cartridge is detachably mountable, said apparatus comprising:
(A) a force applying means;
(B) a mounting portion for mounting said process cartridge, said process cartridge including,
a second frame coupled with said first frame for rotation about a shaft;
an electrophotographic photosensitive drum provided in said first frame;
a developing roller, provided in said second prime, for developing an electrostatic latent image formed on said photosensitive drum with a developer;
a stretching spring for applying an elastic force between said first frame and said second frame to urge said developing member to said photosensitive drum;
a laser beam path for permitting passage of a laser beam to be projected onto said photosensitive drum from the main assembly of the image forming apparatus when said process cartridge is mounted to the main assembly of an image forming apparatus, said laser beam path being disposed between said first frame and said second frame at a downstream portion with respect to the mounting direction;
a force receiving portion, provided downstream of said shaft with respect to a mounting direction in which said process cartridge is mounted to the main assembly of said image forming apparatus, for receiving a force from the main assembly of the image forming apparatus to keep said developing member away from said photosensitive drum when said process cartridge is mounted to the main assembly of the image forming apparatus; and
wherein said force receiving portion is disposed at one and the other longitudinal and portions at such a position that said force receiving portion does not interfere the laser beam path with respect to a vertical direction when said process cartridge is mounted to the main assembly of image forming apparatus;
a first limiting portion for limiting upward movement of said first frame, wherein said first limiting portion is disposed at one end portion of said first frame with respect to a direction crossing with the mounting direction and at a downstream position with respect to the mounting direction, and said first limiting portion is projected from said first frame with respect to the direction crossing with the mounting direction;
a second limiting portion for limiting upward movement of said first frame, wherein said second limiting portion is disposed at the other end portion of said first frame with respect to a direction crossing with the mounting direction and at a downstream position with respect to the mounting direction, and said second limiting portion is projected from said first frame with respect to the direction crossing with the mounting direction;
wherein a contact position where said developing roller is contacted to said photosensitive drum is upstream of said shaft.

16. A process cartridge according to any one of claims 13, 14 and 15, wherein said mounting portion includes one mounting means for mounting a process cartridge for black color development and three mounting means for mounting process cartridges for non-black color development, and wherein said force applying portion includes a first force applying means for applying the force to the force receiving portion of the process cartridge for black color development mounted to the mounting means therefor, and second force outlined means for applying the force to the force receiving portion of the process cartridges for non-black color development.

17. A separating mechanism for separating a developing member from an electrophotographic photosensitive drum provided in a process cartridge detachably mountable, said separating mechanism comprising:
(A) a main assembly of an electrophotographic image forming apparatus, to which the process cartridge is detachably mountable, said main assembly including a force applying means; and
(B) a mounting portion for mounting said process cartridge, said process cartridge including,
a first frame;
a second frame coupled with said first frame for rotation about a shaft;
an electrophotographic photosensitive drum provided in said first frame;
a developing member, provided in said second frame, for developing an electrostatic latent image formed on said photosensitive drum with a developer;
an elastic member for applying an elastic force between said first frame and said second frame to urge said developing member to said photosensitive drum;
a force receiving portion, provided downstream of said shaft with respect to a mounting direction in which said process cartridge is mounted to the main assembly of said image forming apparatus, for receiving a force from the main assembly of the image forming apparatus to keep said developing member away from said photosensitive drum when said process cartridge is mounted to the main assembly of the image forming apparatus; and
a limiting portion for limiting upward movement of said first frame.
wherein a force for raising said second frame upwardly is applied to said force receiving portion by said force applying means of said main assembly of said image forming apparatus while said regulating portion limits the upward movement of said first frame, to keep said developing member away from said photosensitive drum.

18. A separating mechanism according to claim 17, wherein said force receiving portion is disposed at each of longitudinal end portions of said second frame.

19. A separating mechanism according to claim 18, wherein said force receiving portion is provided at two positions at said one longitudinal end portion and at two positions at the other longitudinal end portion, wherein said four force receiving portions face downward when said process cartridge is amounted to the main assembly of the image forming apparatus, wherein for said process cartridge accommodating a developer for development with black color, one of said force receiving portions disposed at said one longitudinal end portion and one of said force receiving portions disposed at the other longitudinal end portion receive the force from the main assembly of apparatus; for said process cartridge accommodating a developer for development with color other than black color, the other of said force receiving portions disposed at said one longitudinal end portion and the other of said force receiving portions disposed at the other longitudinal end portion receive the force from the main assembly of apparatus.

20. A separating mechanism according to claim 17, wherein said linking portion is disposed at one end portion of said first frame with respect to a direction crossing with the mounting direction and at a downstream position with respect to the mounting direction, and said limiting portion is projected from said first frame with respect to the direction crossing with the mounting direction.
